(19) United States
(12) Patent Application Publication
(10) Pub. No.: US 2007/0299167 A1
(43) Pub. Date: Dec. 27, 2007

(54) Two-part bio-based furfuryl adhesive composition for engineered wood

(76) Inventors: Gang-Fung Chen, Dublin, OH (US); Jianxia Chen, Dublin, OH (US)

Correspondence Address: MUELLER AND SMITH, LPA;MUELLER-SMITH BUILDING, 7700 RIVERS EDGE DRIVE, COLUMBUS, OH, 43235, US

(21) Appl. No.: 11/474,183

(22) Filed: Jun. 23, 2006

(51) Int. Cl. B32B 21/04; C09J 197/00; C08K 9/04

(52) U.S. Cl. 524/72; 428/537.1; 524/445

(57) ABSTRACT

Adhesive composition derived from tannin-furfuryl alcohol catalyzed by acid in a two-part aqueous system is used to bond a variety of wood substrates to give good bond strength and high percentage of wood failure. The reactivity of the mixed adhesive can be controlled by the proper selection of acid catalyst, catalyst concentration, and adhesive composition. This gives adhesive with a wide range of open time during processing. This adhesive system can be either cold set or heat activated. It can also be cured by radio frequency similar to typical industrial settings. These characteristics make this adhesive system suitable for a number of engineered wood applications such as finger joint, Glulam, I-joist, and LVL.

### CROSS-REFERENCE TO RELATED APPLICATIONS

None

### STATEMENT REGARDING FEDERALLY SPONSORED RESEARCH

Not applicable.

### BACKGROUND OF THE INVENTION

The present invention generally relates to adhesives for joining wood products, and more particularly to a tannin/furfuryl alcohol adhesive therefor.

The engineered wood industry has been facing a strong challenge to produce stronger and better-engineered wood products for consumers. In the past 50 years the world supply of wood has been decreasing in size, making efficient utilization of smaller wood species crucial and a great challenge. Engineered wood requires an adhesive to perform well under a variety of environmental conditions to meet strict demand and requirements for various applications. This invention relates an adhesive composition derived from tannin and furfuryl alcohol solution in a two-part system for use in the manufacture of engineered wood products, such as finger joint, LVL, Glulam, and I-joist.

The adhesives for such bonded or laminated wood products conventionally are based on phenol-formaldehyde, urea-formaldehyde, polyvinyl acetate, resorcinol-formaldehyde, polymeric diphenylmethane diisocyanate (MDI), and hot met adhesives. The glued wood products include plywood, particleboard, oriented strand board (OSB), medium density fiberboard (MDF), laminated veneer lumber (LVL), laminated beams, and a variety of other engineered wood products. Among them, laminated beams, I-beams, LVL, and a variety of engineered wood products are used for structural wood applications. Generally, these engineered wood products require an initial finger jointing of short pieces of wood or parallel laminated veneers (PLV) before they can be constructed into long and/or thick beams or lumbers and in the case of I-Beams an adhesive is required to assemble the I-Beam itself. A fast curing structural adhesive is required to manufacture I-Beams in both the web-to-flange joint as well as the butt joint between web pieces. Consequently, it is important that, in the finger-jointed area and the I-Beam bonding areas, the adhesive have good strength, structural adhesive properties, and cure quickly. For present purposes, all of the foregoing products are known as “laminated wood products.”

The use of tannin and furfuryl alcohol as an adhesive to bond wood particles has been cited in the literature. For example, Torosa and Pizzi (A. Torosa, A. Pizzi, Holz als Roh-und Werkstoff, 56 (1998) 213-214) described the use of Quebracho tannin and furfuryl alcohol for making industrial fiberboard and laboratory particleboard. In the adhesive preparation for fiberboard, adhesive was obtained by adding furfuryl alcohol to the aqueous solution of Quebracho tannin containing H₂SO₄. The mixture was reacted at 80° C. for 30 minutes and the exothermic reaction was controlled by cooling and addition of sodium hydroxide to produce a liquid adhesive with 29% solids at pH of 10.7. In the adhesive preparation for the laboratory particleboard, pine tannin was first dissolved in water and furfuryl alcohol. This tannin solution then was mixed with morpholine salt of p-toluenesulfonic acid aqueous solution in a ratio of 10:1. Torosa and Pizzi were primarily concerned with the violent reactive nature of furfuryl alcohol condensation under acid catalysis. Consequently, in the fiberboard application, furfuryl alcohol and Quebracho tannin were already in the form of resinous material in aqueous solution. In the particleboard application, the acid catalyst was partially neutralized by morpholine to decrease the catalysis effect for stability.

### BRIEF SUMMARY OF THE INVENTION

Adhesive composition derived from tannin-furfuryl alcohol catalyzed by acid in a two-part aqueous system is used to bond a variety of wood substrates to give good bond strength and high percentage of wood failure. The reactivity of the mixed adhesive can be controlled by the proper selection of acid catalyst, catalyst concentration, and adhesive composition. This gives adhesive with a wide range of open time during processing. This adhesive system can be either cold set or heat activated. It can also be cured by radio frequency similar to typical industrial settings. These characteristics make this adhesive system suitable for a number of engineered wood applications such as finger joint, Glulam, I-joist, and LVL.

The present invention separates furfuryl alcohol from acid in a two-component adhesive system. Furfuryl alcohol and water are known to be excellent penetration agent to wood species. When aqueous solution of furfuryl alcohol containing tannin is applied to the surface of wood, deep penetration is expected. In the presence of acid, this adhesive reacts and cross-links to give strong bond. Various thickeners and clays also are incorporated into either component to promote smooth mixing and to enhance the wood bonding performance.

### DETAILED DESCRIPTION OF THE INVENTION

Adhesives are an important part of structural engineered wood, which includes finger joints, glue laminated (Glulam) beams, laminated veneer lumber (LVL), and I-joists. For engineered wood to possess requisite structural properties, the adhesive must form a strong bond, particularly under wet conditions, for exterior application. In this aspect, bond performance (usually determined by strength and wood failure percentage) often is used as the criterion to determine whether or not the adhesive is suitable for these applications. Various test methods, such as those described in ASTM and CSA testing methods, are already established for this purpose.

For wood bonding applications, there are numerous processing considerations for the adhesive to work properly during processing. For example, in the Glulam beam applications, the adhesive typically is required to have a slow (>45 minutes) cure rate to allow lengthy processing time. On the other hand, in finger joint applications, the adhesive is required to cure fast during processing for maximum output. With respect to the press pressure for wood laminates, use of too low of a press pressure can lead to improper adhesive bonding and use of too high of a press pressure can lead to a phenomenon called “glue starvation”. Both scenarios can result in poor bond performance. Glue starvation also relates to several other factors, such as, for example, adhesive viscosity, open assembly time (OAT), close assembly time (CAT), and cure speed. The art generally teaches that adhesives having lower viscosities or molecular weights tend to have better penetration into wood than adhesives with higher viscosity or molecular weight. However, adhesives with lower viscosities or molecular weights tend to be squeezed out of the bond joint easily under pressure. Consequently, the relationship of OAT, CAT, and adhesive cure speed to adhesive bonding performance is an important consideration for any engineered wood assembly application.

The adhesive disclosed herein is a two-part system, Part A component and Part B component, which components are mixed at different ratios prior to application. A key of this invention is to pre-separate acid from the furfuryl alcohol component before forming the two-part adhesive composition. When Quebracho extract is dissolved in furfuryl alcohol and water as component A, the acid is included in the B component, which may contain water, emulsion polymer, clay, or other thickeners. When Quebracho extract is dissolved in water without furfuryl alcohol, acid can be incorporated into this aqueous component A with slow viscosity increase over time for a few weeks, depending on acid concentration. In this latter case, furfuryl alcohol can be used to dissolve and disperse thickeners and clay, as component B. Alternatively, clay or thickeners can be incorporated into either component, depending on the requirement of application viscosity. It should be noted that the clay selected should exhibit a pH of not substantially greater than about 7.0 when dispersed in water in the mixture since it will neutralize the acid catalyst. It is also understood that the presence of clay helps to retain adhesive in the bond line under press pressure and, thus, reduces the potential of glue starvation.

The cure speed of the mixed adhesive is highly dependent on the acid catalyst concentration in the final adhesive mixture. Cure speed can be as fast as <5 minutes to as long as >1.5 hours at ambient temperature. Cure speed also can be accelerated by the use of heat, such as is supplied in a hot press.

A particularly important feature of the disclosed adhesive is its cure behavior. Due to the rapid condensation reaction of furfuryl alcohol under acid catalysis conditions, the applied adhesive composition rapidly reaches almost full cure as the adhesive commences curing, which results in a brittle black solid depending on the mix ratio of component A and component B. This desirable rapid cure rate makes the disclosed adhesive composition extremely suitable for industrial finger joint applications.

Tannins occur in nearly every plant from all over the world and in all climates. Tannins appear yellow-white to brown and deepen in color when exposed to light. Tannin is found in almost any part of the plant—from roots to leaves and bark to unripe fruit. Tannin can be used in tanning animal skins to make leather, as it transforms certain proteins of animal tissue into compounds that resist decomposition. Examples of plant species used to obtain tannins for tanning purposes are wattle (Acacia sp.), oak (Quercus sp.), eucalyptus (Eucalyptus sp.), birch (Betula sp.), willow (Salix caprea), pine (Pinus sp.), quebracho (Scinopsis balansae). Additionally, tannin can be obtained from mimosa bark tannin, pecan nut pith tannin, and gambier short, and leaf tannin. Tannin also is used in manufacturing inks, as a mordant in dyeing, and in medicine as an astringent, and for treatment of burns. Tannin tends to concentrate in the bark layer of most trees, where it forms a barrier against microorganisms, such as fungi and bacteria. In modern times, about 80% of all commercial bark tanning is done with highly concentrated extracts of Quebracho, Chestnut, or Mimosa. From a molecular structure perspective, tannins are phenolic compounds and are composed of a very diverse group of oligomers and polymers with multiple structural units and free phenolic groups. Tannin has molecular weight ranging from about 500 to greater than about 20,000. Most tannin compounds are soluble in water, except for some of the high molecular weight structures, and are able to bind proteins and form insoluble or soluble tannin-protein complexes. Tannin varies somewhat in composition, having the approximate empirical formula: C₇₆ H₅₂ O₄₆.

Furfuryl alcohol is obtained from abundant agricultural and forestry waste products. Furfuryl alcohol is colorless, liquid, and a primary alcohol. Upon exposure to air, furfuryl alcohol gradually darkens in color. Both furfuryl alcohol and furfural fall in the category of organic chemical feedstocks, which are both non-oil derived and in abundant and fairly economical supplies. They both present the characteristic reactions of aldehydes and aromatic alcohols toward phenol, as well as the capability of their substituted aromatic furanic rings to react similarly to phenols towards formaldehydes and other aldehydes. Under acidic conditions, furfuryl alcohol polymerizes to black resinous polymers. Co-condensations also occur with phenolic compounds, formaldehyde, and/or other aldehydes. Acid-catalyzed resinification is the most important industrial reaction of furfuryl alcohol. The chemistry of furfuryl alcohol polymerization initiated by heat, acidic catalysts has been studied at various laboratories (See, for example, A. K. A. Rathi and M. Chanda, J. Appl. Polym. Sci, 18, (1974) 1541; T. A. Krishnan and M. Chanda, Angew. Makromol. Chem. 43, (1975), 145; R. H. Wewerka, E. D. Loughran, and K. L. Walters, J. Appl. Polym. Sci. 15, (1971), 1437).

The polymerization of furfuryl alcohol is highly exothermic and, depending upon the activity and concentration of the acid catalyst used, requires careful control of the reaction temperature. Furfuryl alcohol resins are derivatives of agricultural waste products and the complex polymers that are formed in a condensation reaction occur when the furfuryl alcohol is acidified. The resins have low viscosity with an odor of furfuryl alcohol. The resin systems are highly reactive and can be catalyzed using a variety of active and latent acidic catalysts. Acid catalysis leads to polymers that are heat resistant and extremely corrosion resistant to acids, bases, and solvents. For these reasons, both furfuryl alcohol and furfural represent raw materials, which are very suitable for the preparation of polymers and resins. They are already used, based on their self-condensation reaction to form polymers under acid conditions, to prepare acid-setting, thermo-setting and cold-setting furanic resins used for foundry core applications (A. Pizzi, E. Orovan and F. A. Cameron, Holzals Roh-und Werkstoff, 42 (1984), 467-472).

Since the disclosed mixed adhesive consists of various polar materials and ionic species, this adhesive also can be cured by radio frequency in a typical industrial finger joint assembly setting. The examples demonstrate that wood laminates formed with disclosed adhesive formulation have excellent bond performance, which includes deep and high percentage of wood failure under different processing conditions, either ambient or heat cure. The acid catalyst can be converted into a salt by neutralization with metal oxides, such as CuO (II), for use as a latent catalyst. The use of a latent catalyst serves two important functions: (1) shelf stability, and (2) helps heat activated curing, such as by radio frequency curing.

Suitable aqueous emulsion polymers for Part B include, inter alia, one or ore of polyvinyl acetate copolymers, such as, for example, Vinac XX-210, Vinac XX-230, Vinac XX-240, or Vinac 1000; vinyl acetate-ethylene copolymer, such as, for example, Airflex 420, Airflex 421, or Vinac 423; vinyl-ethylene-chloride copolymers such as Airflex 430, Airflex 4500; Airflex 4530; or vinyl acetate copolymer and acrylic emulsions such as Flexbond series all listed products supplied by Air Products and Chemicals, Inc., Allentown, Pa.)

Acid catalysts include catalysts that may be either organic or inorganic acids. The organic acid catalyst may include, but are not limited to, one or more of the following: acetic acid, tartaric acid, citric acid, para-toluene sulfonic acid, benzenesulfonic acid, oxalic acid, trichloroacetic acid, or formic acid; the inorganic acid may include, but are not limited to, one or more of sulfuric acid, hydrochloric acid, or phosphorous acid. Acid salts derived from weak base and strong acid, which exhibit acidic characteristics upon dissociation, also may be used to promote or accelerate chemical reactions. Examples of weak base to be used forming acid salt include one or more of metal oxides such as iron oxide, copper oxide, aluminum oxide, zinc oxide, and aluminum oxide.

Water soluble thickeners, which may be used may include, but not limited to, one or more of polyethylene oxide such as Polyox™ WSR N750, Polyox™ WSR N3000, or Polyox™ WSR 1105 (Dow Chemical Co., Midland, Mich.); or cellulose ether such as Methocel™ 327 (Dow Chemical Co., Midland, Mich.); or hydroxypropyl methycellulose such as Methocel™ F4M (Dow Chemical Co., Midland, Mich.); or Polacryl BR-100 (Polacryl Inc.).

Fillers or clays can be used to fill the gap and at the same time may be used to control viscosity or flow characteristics for either component, so long as these fillers do not exhibit a pH of not substantially greater than about 7.0. Examples of filler include, for example, cellular filler (grade 43BC from Silbrico Corporation), Kaolin clays (grade Amlok 321 from Kentucky-Tennessee clay Co.), or ball clays (#1 ball clay from Old Hickory Co.).

The following examples show how the present invention has been practiced, but should not be construed as a limitation of the invention. In this application all units are in the metric system and all amounts and percentages are by weight, unless otherwise expressly indicated.

### EXAMPLES

### Example 1

### Effect of Acid Catalyst and Its Concentration

Quebracho extract is easily soluble in either water or furfuryl alcohol by simple blending to form a homogeneous dark-brown solution. The viscosity of the solution is dependent on the Quebracho concentration. To evaluate the cure speed of the Quebracho extract solution catalyzed by acid, a base solution of Quebracho extract was first prepared by dissolving 35 parts of Quebracho extract in 65 parts of furfuryl alcohol. This base Quebracho extract solution containing 35% of Quebracho was designated as “QF”.

Various acids were incorporated into QF at different concentrations to see the effect of cure speed. When QF contained 1% or 2% acetic acid, no apparent reaction was observed overnight. When QF was mixed with aqueous phosphoric acid (10%) at 8/1, 4/1, 2/1, and 1/1 ratios, the mixture thickened progressively and eventually became a black brittle solid after 3 days. When QF was mixed with aqueous oxalic acid (10%) at 20/2, 20/3, 20/4, and 20/6 ratios, it became a viscous dark liquid after 16 hours, and black brittle solids after 2 days. When QF was mixed with aqueous para-toluenesulfonic acid (10%, p-TSA) at various mix ratios (from 20/0.5 to 20/4.0), it progressively became a viscous black liquid or black solid after 20 hours. The measured pH's of the adhesive system containing p-TSA ranged from 1.4 to 4.3, depending on the acid concentration.

To evaluate the adhesive performance on wood laminated assembly, QF was mixed with aqueous solutions containing 20% p-TSA at different mix ratios and applied by a paint brush to the surface of black spruce fir. Tests were performed in a manner according to the vacuum-pressure portion of ASTM D-5751 test protocol. The performance data shown in Table 1 demonstrates that there is a strong correlation between performance and p-TSA concentration in the adhesive, evidenced by the bond strength and wood failure.

At the same catalyst concentration shown in 7225-68D entry from Table 1, the effect of Quebracho extract concentration on the performance of wood laminated assembly was studied. Data shown in Table 2 demonstrate that as the Quebracho extract concentration in the furfuryl alcohol increases, the performance improves. Excellent performance was achieved when the Quebracho extract concentration was between 20% and 50%. At this concentration range, adhesive out-performed the control (CX47/A322).

TABLE 1
Vacuum Pressure Test Results of QF Catalyzed by Acid
Substrate: Black Spruce Fir (sp. Gr. = 0.49–50)
Ambient Temperature Press at 250 psi Overnight

| | | CAT | Strength | Wood Failure |
|---|---|---|---|---|
| BN | Formulation | (min) | (psi) | (%) |
| 7225-68A | QF/p-TSA - 25/2.5 | 30 | 17 | 0 |
| 7225-68B | QF/p-TSA - 25/3.0 | 28 | 286 | 0 |
| 7225-68C | QF/p-TSA - 25/4.0 | 26 | 800 | 36 |
| 7225-68D | QF/p-TSA - 25/6.0 | 24 | 848 | 86 |

Notes:
p-TSA was 20% concentration in water

TABLE 2
Vacuum Pressure Test Results of Adhesive - Quebracho
Concentration Effect
Quebracho/Furfuryl Alcohol Solution mixed with 20% p-TSA
Aqueous Solution at 25/6 Mix Ratio
Black Spruce Fir (Sp. Gr. = 0.49–50), Ambient Press
@ 250 psi for 2 days

| | Formulation | | | |
|---|---|---|---|---|
| | Quebracho | | | Wood |
| | % in Furfuryl | CAT | Strength | Failure |
| BN | Alcohol | (min) | (psi) | (%) |
| 7225-81A | 0 | 24 | 93 | 3 |
| 7225-81B | 10 | 22 | 809 | 70 |
| 7225-72A | 20 | 15 | 859 | 96 |
| 7225-72B | 30 | 13 | 875 | 94 |
| 7225-72C | 40 | 11 | 947 | 96 |
| 7225-72D | 50 | 9 | 869 | 93 |
| 7225-81G | CX-47/A322 - 7.5/50 | 10 | 691 | 27 |
| 7225-81H | CX-47/A322 - 7.5/50 | 8 | 751 | 20 |

The results obtained from Tables 1 and 2 were further confirmed in a study of cure behavior relationship with the mix ratio and acid concentration. Aqueous solutions containing p-TSA and hydrochloric acid (HCl) at different concentrations were prepared. Additionally, two Quebracho/furfuryl alcohol solutions at 20/80 and 50/50 ratios were prepared for this study. The 20/80 solution is designated as QF1 and the 50/50 solution is designated as QF2. QF1 and QF2 then were mixed with an aqueous solution containing p-TSA at different concentrations at a 25/6 mix ratio. The results recorded are displayed in Table 3.

TABLE 3
Experimental Observations to Address Acidity Issue
(p-TSA System)

| | | | | |
|---|---|---|---|---|
| | Total Calc. | Exo. | | |
| | acid % | Time | | |
| Mix ratio | in mixture | (min) | 1 day | 2 days |

Quebracho/furfuryl Alcohol - 20/80 as QF1

| | | | | |
|---|---|---|---|---|
| QF1/7225-171A - 25/6 | 1% | >3 hrs | SBS | BS |
| QF1/7225-171B - 25/6 | 2% | >3 hrs | BBS | BBS |
| QF1/7225-171C - 25/6 | 3% | 42 min | BBS | BBS |

Quebracho/furfuryl Alcohol - 50/50 as QF2

| | | | | |
|---|---|---|---|---|
| QF2/7225-171A - 25/6 | 1% | >3 hrs | BBS | BBS |
| QF2/7225-171B - 25/6 | 2% | 32 min | BBS | BBS |
| QF2/7225-171C - 25/6 | 3% | 12 min | BBS | BBS |

7225-171A is an aqueous solution containing 5.17% p-TSA
7225-171B is an aqueous solution containing 10.33% p-TSA
7225-171C is an aqueous solution containing 15.50% p-TSA
SBS denotes soft black solid, BS denotes black solid, & BBS denotes brittle black solid.
Exo. Time was determined by observing slight bubbling and temperature rise of mixed adhesive (about 20 g in 4 oz paper cup).

TABLE 4
Experimental Observations to Address Acidity Issue
(Hydrochloric acid system)

| | | | | |
|---|---|---|---|---|
| | Total Calc. | Exo. | | |
| | acid % | Time | | |
| Mix ratio | in mixture | (min) | 1 day | 2 days |

Quebracho/furfuryl Alcohol - 20/80 as QF1

| | | | | |
|---|---|---|---|---|
| QF1/8N HCl/H₂O - 25/0.51/2.90 | 0.45 | >3 hrs | SBS | SBS |
| QF1/8N HCl/H₂O - 25/1.04/2.37 | 0.92 | 61 min | BBS | BBS |
| QF1/8N HCl/H₂O - 25/2.17/1.24 | 1.91 | 12 min | BBS | BBS |
| QF1/8N HCl/H₂O - 25/3.41/0 | 3.00 | 4 min | BBS | BBS |

Quebracho/furfuryl Alcohol - 50/50 as QF2

| | | | | |
|---|---|---|---|---|
| QF2/8N HCl/H₂O - 25/0.51/2.90 | 0.45 | >3 hrs | BBS | BBS |
| QF2/8N HCl/H₂O - 25/1.04/2.37 | 0.92 | 15 min | BBS | BBS |
| QF2/8N HCl/H₂O - 25/2.17/1.24 | 1.91 | 4 min | BBS | BBS |
| QF2/8N HCl/H₂O - 25/3.41/0 | 3.00 | 2 min | BBS | BBS |

SBS denotes soft black solid, BS denotes black solid, & BBS denotes brittle black solid.
Exo. Time was determined by observing slight bubbling and temperature rise of mixed adhesive (about 20 g in 4 oz paper cup).

The above-tabulated results shown in Table 3 with the p-TSA catalyzed system indicate that, at the same total calculated acid concentration in the adhesive mixture, the adhesive derived from QF2 cured much faster than adhesive derived from QF1, evidenced from the observed exo., time, and appearance of the cured adhesive. Similarly, the same conclusion is obtained with the hydrochloric acid catalyzed system, shown in Table 4. That is, at the same total calculated acid concentration in the adhesive mixture, the adhesive derived from QF2 cured much faster than adhesive derived from QF1.

This results further demonstrate that the importance of an Quebracho and furfuryl alcohol ratio in this adhesive system. Additionally, data shown in Table 3 indicate that when p-TSA is used as a catalyst, the required acid concentration to cure QF1 and QF2 to black brittle solids is approximately 2% and 1%, respectively. When HCl was used as a catalyst, the required HCl concentration to cure QF1 and QF2 to black brittle solids is approximately 0.92% and 0.45%, respectively.

### Example 2

### Adhesive Containing Methylcellulose

Since the mixtures of QF and p-TSA aqueous solution were low in viscosity (Tables 1 & 2 from Example 1), various thickeners were evaluated to increase the mix viscosity. These thickeners included Levan (a polysaccharide), polyvinyl alcohol, poly(ethylene oxide), and methylcellulose. Depending upon the thickener used, generally about 2 to about 10% of these thickeners can considerably increase the viscosity of the p-TSA aqueous solution. Performance data displayed in Table 3 were derived from adhesives made by mixing the QF (component A) and aqueous solution containing 2%-3% of methylcellulose at different p-TSA concentration at different mix ratios.

It can be seen from Table 5 that as the p-TSA concentration in the aqueous solution increases, the speed of cure increases, evidenced by the exothermic time. At 25% p-TSA concentration (7225-99 series), the adhesive mixtures cured to brittle, black solids in 7-9 minutes. At 5% p-TSA concentration, the observed exothermic time was greater than 120 minutes.

Selected adhesives also were used for wood laminated assembly shown in Table 5. It can be seen that the bond performance is dictated by the p-TSA concentration in the adhesive mixtures. At 5% p-TSA concentration in aqueous solution containing methylcellulose, low strength and wood failure is seen at all mix ratios with QF. At 15% and 20% p-TSA concentrations in aqueous solution containing methylcellulose, good strength and high percentage of wood failure is obtained. The low observed wood failure (37%, 7225-106F) is presumably due to the low p-TSA concentration in the adhesive derived from QF/7225-100B at 4/1 mix ratio. Furthermore, with proper catalyst concentration and mix ratio, bond performance out-performed the control (CX47/A322).

It is important to note that with proper selection of catalyst concentration and mix ratio, the adhesives may be suitable for Glulam beam application where long open time is needed, such as entries 7225-106D & E shown in Table 5.

TABLE 5
Vacuum Pressure Test Results of Adhesive Derived from QF &
Various Aqueous Solution Containing 2–3% of Methylcellulose Solution
at Different p-TSA Concentrations and at Different Mix Ratios
Ambient Pressed at 250 psi for 1 day
Black Spruce fir (sp. gr. = 0.48 to 0.50)

| | | Exo. Time | Lay-up Condition & Performance | | |
|---|---|---|---|---|---|
| BN | Formulation | (min) | CAT (min) | Strength (psi) | WF % |

Methylcellulose Aqueous Solution Containing 25% p-TSA (7225-98D)

| | | |
|---|---|---|
| 7225-99A | QF/7225-98D - 5/1 | 7′40″ |
| 7225-99B | QF/7225-98D - 4/1 | 7′30″ |
| 7225-99C | QF/7225-98D - 3/1 | 7′ |
| 7225-99D | QF/7225-98D - 2/1 | 7′20″ |
| 7225-99E | QF/7225-98D - 1/1 | 8′ |

Methylcellulose Aqueous Solution Containing 20% p-TSA (7225-98B)

| | | | | | |
|---|---|---|---|---|---|
| * | QF/7225-98B - 5/1 | 15′ | | | |
| 7225-105G | QF/7225-98B - 4/1 | 15′30″ | 4 | 756 | 76 |
| | QF/7225-98B - 3/1 | 17′ | | | |
| 7225-105F | QF/7225-98B - 2/1 | 17′ | 6 | 771 | 89 |
| 7225-105E | QF/7225-98B - 1/1 | 20′ | 8 | 904 | 79 |

Methylcellulose Aqueous Solution Containing 15% p-TSA (7225-100A)

| | | | | | |
|---|---|---|---|---|---|
| | QF/7225-100A - 5/1 | 31′ | | | |
| 7225-105C | QF/7225-100A - 4/1 | 33′ | 14 | 806 | 90 |
| | QF/7225-100A - 3/1 | 35′ | | | |
| 7225-105B | QF/7225-100A - 2/1 | 38′ | 16 | 821 | 85 |
| 7225-105A | QF/7225-100A - 1/1 | 41′ | 18 | 817 | 78 |

| | | | | |
|---|---|---|---|---|
| 7225-105D | A322/CX47 - 100/15 Control for above | 10 | 798 | 40 |

Methylcellulose Aqueous Solution Containing 10% p-TSA (7225-100B)

| | | | | | |
|---|---|---|---|---|---|
| | QF/7225-100B - 5/1 | 100′ | | | |
| 7225-106F | QF/7225-100B - 4/1 | 97′ | 24 | 815 | 37 |
| | QF/7225-100B - 3/1 | 88′ | | | |
| 7225-106E | QF/7225-100B - 2/1 | 90′ | 26 | 827 | 83 |
| 7225-106D | QF/7225-100B - 1/1 | 104′ | 28 | 960 | 81 |

Methylcellulose Aqueous Solution Containing 5% p-TSA (7225-100C)

| | | | | | |
|---|---|---|---|---|---|
| | QF/7225-100C - 5/1 | >120′ | | | |
| 7225-106C | QF/7225-100C - 4/1 | >120′ | 30 | 0 | 0 |
| | QF/7225-100C - 3/1 | >120′ | | | |
| 7225-106B | QF/7225-100C - 2/1 | >120′ | 32 | 190 | 7 |
| 7225-106A | QF/7225-100C - 1/1 | >120′ | 34 | 546 | 38 |

| | | | | |
|---|---|---|---|---|
| 7225-106G | A322/CX47 - 100/15 Control for above | 10 | 697 | 20 |

Exothermic time was obtained by observing the time when 20 gram of the mixed adhesive in a 4 oz paper cup began to show apparent bubbling and temperature rise.

### Example 3

### Adhesive Contains Emulsion Polymer Catalyzed by p-TSA

There are a number of emulsion polymers, particularly polyvinyl acetate or the same derived from ethylene copolymer, known to be excellent adhesive for wood bonding. The advantage of incorporating an emulsion polymer, particularly the polyvinyl acetate type, is that it can be crosslinked by acid, thus adding an extra structural property to improve performance. Additionally, furfural is known to react with poly(vinyl alcohol) under acid catalysts to effect acetalization of the hydroxyl group. To explore this potential, various emulsion polymers containing acid catalyst were evaluated. However, in this adhesive system the mix ratio had to be carefully chosen. If the mixture were rich in QF, the mixture gelled immediately and eventually became a dark solid, depending on different emulsion polymers used. For example, when QF was mixed with Airflex 426 or Vinac 210 at a 4:1 ratio containing 10% p-TSA, the mixture gelled immediately. This probably is due to the coagulation of emulsion polymer by furfuryl alcohol. However, when QF was mixed with the same emulsion polymer at 1:4 ratio, it mixed well and cure overnight, depending on the acid concentration.

Data shown in Table 6 demonstrate that both p-TSA and oxalic acid catalyzed the mixed adhesive of Vinac 210 and QF solution to give good bond strength and outstanding wood failure, relative to the control of CX-47/A322.

TABLE 6
Vacuum Pressure Test Results of Adhesive Derived from QF & Vinac 210
Catalyzed by Different Acids & Concentrations
Black Spruce Fir (Sp. Gr. = 0.49–50)

| | | | | |
|---|---|---|---|---|
| | | | Strength | |
| LB# | Formulation | CAT (min) | (psi) | WF % |

Performance (hot pressed at 250° F. for 4 hrs at 125 psi)

| | | | | |
|---|---|---|---|---|
| 7225-79E | Vinac 210/QF/p-TSA - 24/6/3.0 (a) | 12 | 792 | 76 |
| 7225-79F | Vinac 210/QF/p-TSA - 22.5/7.5/3.0 (a) | 10 | 842 | 78 |
| 7225-79G | Vinac 210/QF/p-TSA - 21/10.5/6.0 (b) | 8 | 857 | 89 |
| 7225-79H | Vinac 210/QF/p-TSA - 15/15/6.0 (b) | 6 | 807 | 94 |

Performance (hot pressed at 250° F. overnight at 125 psi)

| | | | | |
|---|---|---|---|---|
| 7225-82A | Vinac 210/QF/oxalic acid - 21/10.5/4 (c) | 22 | 561 | 86 |
| 7225-82B | Vinac 210/QF/oxalic acid - 21/10.5/6 (c) | 20 | 720 | 96 |
| 7225-82C | Vinac 210/QF/oxalic acid - 21/10.5/8 (c) | 18 | 722 | 90 |
| 7225-82D | Vinac 210/QF/oxalic acid - 15/15/4 (c) | 16 | 702 | 85 |
| 7225-82E | Vinac 210/QF/oxalic acid - 15/15/6 (c) | 14 | 775 | 98 |
| 7225-82F | Vinac 210/QF/oxalic acid - 15/15/8 (c) | 12 | 735 | 87 |
| 7225-82G | CX47/A322 - 7.5/50 | 10 | 849 | 86 |
| 7225-82H | CX47/A322 - 7.5/50 | 8 | 797 | 68 |

Note:
(a) 20% p-TSA,
(b) 10% p-TSA, and
(c) 10% oxalic acid

### Example 4

### Effect of Furfuryl Alcohol Concentration

To promote the miscibility of the two-part aqueous system, water also was introduced into a Quebracho extract and furfuryl alcohol solution. A series of Quebracho extract solutions was prepared by dissolving 40 parts of Quebracho extract in 60 parts of water/furfuryl alcohol at different ratios of the part A component, designated as QWF (Quebracho, water, & furfuryl alcohol). The three QWF mixes containing different furfuryl alcohol concentrations were then mixed with the part B component of a methylcellulose aqueous solution containing 15% p-TSA at 4/1 and 1/1 mix ratios. Results shown in Table 7 demonstrate that good performance was obtained relative to the control, CX47/A322. There appears to be no performance difference between 4/1 and 1/1 mix ratios for all adhesives evaluated with furfuryl alcohol concentration in between 40% and 60% in QWF.

On the other hand, when adhesives derived from the same QWF solution (40% Quebracho) were mixed with Airflex 426 emulsion containing 14% p-TSA, data shown in Table 8 demonstrate that there is a performance drop when the furfuryl alcohol concentration was at 30%. Data also demonstrate these adhesives out-performed the control (CX47/A322) both in strength and wood failure.

TABLE 7
Vacuum-Pressure Testy Results of QWF (40% Quebracho)
Mix with Methylcellulose Aqueous Solution Containing 15%
p-TSAAmbient Pressed at 250 psi Overnight
Black Spruce fir (sp. Gr. = 0.48 to 0.50)

| | Mix ratio of | Lay-up Condition & Performance | | |
|---|---|---|---|---|
| | QWF and | CAT | Strength | |
| BN | 7225-100A | (min) | (psi) | WF % |

QWF (40/0/60) Mix with 7225-100A

| | | | | |
|---|---|---|---|---|
| 7225-114A | 4/1 | 20 | 828 | 77 |
| 7225-114B | 1/1 | 18 | 858 | 71 |

QWF (40/10/50) Mix with 7225-100A

| | | | | |
|---|---|---|---|---|
| 7225-114C | 4/1 | 16 | 821 | 76 |
| 7225-114D | 1/1 | 14 | 795 | 71 |

QWF (40/20/40) Mix with 7225-100A

| | | | | |
|---|---|---|---|---|
| 7225-114E | 4/1 | 12 | 743 | 62 |
| 7225-114F | 1/1 | 10 | 929 | 81 |

Control

| | | | | |
|---|---|---|---|---|
| CX47/A322 | 15/100 | 10 | 788 | 39 |
| CX47/A322 | 15/100 | 8 | 774 | 59 |

Note:
7225-100A is Methylcellulose Aqueous Solution Containing 15% p-TSA

TABLE 8
Vacuum-Pressure Testy Results of QWF (40% Quebracho) Mix
with Airflex 426 Containing 14% p-TSA
Ambient Pressed at 250 psi overnight
Black Spruce fir (sp. Gr. = 0.48 to 0.50)

| | | Lay-up Condition & Performance | | |
|---|---|---|---|---|
| | Mix ratio of | CAT | Strength | |
| BN | QWF and 100A | (min) | (psi) | WF % |

QWF (40/10/50) Mix with 7225-113H

| | | | | |
|---|---|---|---|---|
| 7225-115A | 4/1 | 22 | 878 | 69 |
| 7225-115B | 1/1 | 20 | 833 | 83 |

QWF (40/20/40) Mix with 7225-113H

| | | | | |
|---|---|---|---|---|
| 7225-115C | 4/1 | 18 | 802 | 67 |
| 7225-115D | 1/1 | 16 | 817 | 80 |

QWF (40/30/30) Mix with 7225-113H

| | | | | |
|---|---|---|---|---|
| 7225-115E | 4/1 | 14 | 599 | 18 |
| 7225-115F | 1/1 | 12 | 851 | 53 |

Control

| | | | | |
|---|---|---|---|---|
| CX47/A322 | 15/100 | 10 | 590 | 19 |
| CX47/A322 | 15/100 | 8 | 583 | 19 |

Note:
7225-113H is Airflex 426 containing 14% p-TSA

### Example 5

### Adhesive with Acid Catalyst in A Component

In an effort to increase the application viscosity of the mixed adhesive, Kaolin clay (Amlok 321, from Kentucky-Tennessee Clay Company) also was incorporated into the adhesive system. This may be carried out in two methods. In the first method, Quebracho extract and furfuryl alcohol were separated. Part A component was prepared by dissolving Quebracho extract and p-TSA in water to form a viscous solution depending on Quebracho concentration. Part B component was prepared by dissolving and dispersing a small amount of methylcellulose and Kaolin clay in furfuryl alcohol. This was followed by adding a thickener (BR-100) to form a smooth, viscous mixture.

Adhesive was obtained by mixing part A and part B at different mix ratios. The performance data shown in Table 9 demonstrate that excellent strength and high percentage of wood failure were obtained with these adhesive. The reason for the different close assembly times (CAT) used with different mix ratios was due to the consideration of p-TSA concentration in each mix. At 1:2, 2:3, and 1:1 mix ratios, the calculated total p-TSA concentrations were 3.9%, 4.7%, and 5.9%. High p-TSA concentration provides a faster cure speed, thus a shorter CAT had to be used. Data shown in Table 9 also indicate that the performance of these adhesives substantially out-performed the control (CX47/A322).

With respect the effect of press pressure, it appears that the strength of the wood block was higher with lower press pressures (125 psi) than with higher press pressures (250 psi) used at the corresponding close assembly time. However, this is not reflected in the observed wood failure. It is possible that, while higher press pressure may cause glue starvation, it could promote better adhesive penetration into wood to give a higher percentage of wood failure. In the respect, it was observed that the observed wood failure with these adhesives was deep, relative to the control (CX-47/A322).

TABLE 9
Block Shear Wet Performance after 7 day cure on Black Spruce Fir
(sp. gr. = 0.51)
7225-135B Mix with 7225-132A Application method: Drawn-down

| | | Vacuum-pressure | | |
|---|---|---|---|---|
| | | Test Results | | |
| | Formulation & | CAT | Strength | Wood |
| #Book | Mix Ratio | (min) | (psi) | failure (%) |

Ambient Press at 125 psi

| | | | | |
|---|---|---|---|---|
| 7225-136B | 7225-135B/7225-132A - 1/2 | 30 | 899 | 92 |
| 7225-136D | 7125-135B/7225-132A - 2/3 | 20 | 914 | 89 |
| 7225-136G | 7225-135B/7225-132A - 1/1 | 8 | 900 | 66 |
| 7225-136F | CX-47/A322 | 10 | 889 | 22 |

Ambient Press at 250 psi

| | | | | |
|---|---|---|---|---|
| 7225-136B | 7225-135B/7225-132A - 1/2 | 30 | 797 | 64 |
| 7225-136D | 7125-135B/7225-132A - 2/3 | 20 | 863 | 92 |
| 7225-136G | 7225-135B/7225-132A - 1/1 | 8 | 820 | 92 |
| 7225-136F | CX-47/A322 | 10 | 770 | 20 |

7225-135B consists of Quebracho extract (53.44%), water (34.76%), and p-TSA (11.79%).
7225-132A consists of furfuryl alcohol (56.16%), methylcellulose (1.5%), Kaolin clay (28.18%), BR-100 (4.12%) & water (10.03%).

More attempts were made to explore the lower limit of the acid concentration in the mixed adhesive for ambient temperature applications. A series of part A aqueous solution containing Quebracho at different p-TSA concentrations was prepared, as shown in Table 10. These solutions were then mixed with part B component at a 30/70 mix ratio for ASTM D-5751 performance evaluation. Data shown in Table 11 indicate that when p-TSA catalyst was used, good performance was not obtained till the total calculated acid concentration reached to approximately 1.62%.

TABLE 10
Composition of Part A Containing Different p-TSA
Catalyst Concentration

| Ingredient | 7225-161A | 7225-161B | 7225-161C |
|---|---|---|---|
| Quebracho | 96.1 | 96.6 | 96.3 |
| Water | 82 | 79 | 74 |
| p-TSA | 7.0 | 10.0 | 15.0 |
| Calc. Pure Acid Conc. % | 3.78 | 5.39 | 8.09 |
| Initial viscosity (cps) | 3950 | 2690 | 4300 |

TABLE 11
Effect of Acid Catalyst, Concentration
ASTM D-5751 Performance on Black Spruce Fir (sp. gr. = 0.50)
Adhesive: Part A/Part B —30/70
Ambient Press at 125 psi Overnight

| BN | Part A | Part B | CAT | Dry | Vacuum-p | 2-cycle boil | Total Calc. |
|---|---|---|---|---|---|---|---|
| 7225- | 7225- | 7225- | (min) | (wf %) | (wf %) | (wf %) | acid % |

Ambient Press at 125 psi Overnight

| | | | | | | | |
|---|---|---|---|---|---|---|---|
| -164A | -161A | -162 | 30 | 1244 (56) | 134 (0) | 542 (57) | 1.13% |
| -164B | -161B | -162 | 28 | 1505 (63) | 829 (92) | 442 (36) | 1.62% |
| -164C | -161C | -162 | 26 | 1611 (43) | 865 (95) | 622 (27) | 2.42% |

7225-162 consists of 9.98% water, 55.88% furfuryl alcohol, 1.50% methylcellulose, 28.02% Kaolin, 2.66% BR-100, and 1.96% aqueous solution of NaOH (5%).

### Example 6

### Adhesive with Acid Catalyst in B Component

The second method was to dissolve Quebracho in water and furfuryl alcohol as a part A component. The part B component was prepared by dispersing and dissolving a small amount of methylcellulose in water under agitation. This is followed by adding p-TSA, clay, and thickener BR-100 to form a viscous solution. Adhesive was obtained by mixing part A and part B at different mix ratios to form a homogeneous viscous mixture. Results of bond performance using different CAT and press pressure are shown in Table 12. Similar to the results shown in Table 9 of Example 5, excellent performance was obtained relative to the control (CX47/A322), particularly the wood failure.

TABLE 12
Block Shear Wet Performance after 7 days Cure
on Black Spruce Fir (sp. gr. = 0.51)
7225-135A Mix with 7225-132B
Application method: Drawn-down

| | | Vacuum-pressure | | |
|---|---|---|---|---|
| | | Test Results | | |
| | Formulation & | CAT | Strength | Wood |
| #Book | Mix Ratio | (min) | (psi) | failure (%) |

Ambient Press at 125 psi

| | | | | |
|---|---|---|---|---|
| 7225-136A | 7225-135A/7225-132B - 4/1 | 35 | 840 | 86 |
| 7225-136C | 7225-135A/7225-132B - 2/1 | 25 | 972 | 77 |
| 7225-136E | 7225-135A/7225-132B - 3/1 | 14 | 889 | 69 |
| 7225-136F | CX-47/A322 | 10 | 889 | 22 |

Ambient Press at 250 psi

| | | | | |
|---|---|---|---|---|
| 7225-136A | 7225-135A/7225-132B - 4/1 | 35 | 708 | 51 |
| 7225-136C | 7225-135A/7225-132B - 2/1 | 25 | 780 | 89 |
| 7225-136E | 7225-135A/7225-132B - 3/1 | 14 | 826 | 92 |
| 7225-136F | CX-47/A322 | 10 | 770 | 20 |

7225-135A consists of Quebracho extract (35.93%), furfuryl alcohol (49.4%), methylcellulose (1.2%), & water (13.47%).
7225-132B consists of water (53.08), methylcellulose (1.33%), Kaolin clay (29.67%), BR-100 (4.25%), & p-TSA (11.68%).

### Example 7

### Finger Joint Strength Development

Finger joint application was used to monitor the strength development of the adhesive derived from mixing part A and part B component at 1/1 mix ratio. Part A component was prepared by dissolving Quebracho extract in water containing different concentrations of p-TSA. Part B component was prepared by dissolving methylcellulose in water and furfuryl alcohol. This is followed by dispersing Kaolin clay and BR-100 to form a smooth viscous mixture shown in Table 10.

In the finger joint application, the adhesive was applied into black spruce fir finger joint (2″×3″×4′) and crowded with 300 psi pressure for 5 seconds. Finger jointed assemblies were allowed to stand at ambient temperature at different times to cure before tested in tension strength. Results of tension strength shown in Table 11 demonstrate the strength development of theses adhesives is highly dependent on the acid concentration in the adhesive mixture, evidenced from the 15 minutes strength. Results also demonstrate the rapid cure feature of this adhesive system. It can be seen that, when part B was mixed with part A at high acid concentration, the strength (18,700 lbs to 25,700 lbs) close to or equivalent to solid lumber (average strength for solid lumber was 22,000 lbs) is observed. The control of Isoset UX200/A300 did not show such a rapid strength development.

TABLE 13
Composition of Part A & B for Finger Joint Application
(all in Parts)

| | Part A | | | | Part B |
|---|---|---|---|---|---|
| Material | 7225-138A | 7225-143A | 7225-143B | 7225-143C | 7225-138B |
| Quebracho Extract | 53.44 | 57.04 | 51.00 | 50.52 | — |
| Furfuryl Alcohol | — | — | — | — | 56.17 |
| Water | 34.76 | 29.25 | 31.00 | 27.84 | 10.03 |
| Methylcellulose | — | — | — | — | 1.50 |
| Kaolin clay | — | — | — | — | 28.18 |
| p-TSA | 11.80 | 13.71 | 18.00 | 21.65 | — |
| BR-100 | — | — | — | — | 4.11 |
| Measured viscosity (cps) | 9,540 | 856 | 3,624 | 5,320 | 8,720 |
| Observed exothermic time | 30 minutes | 10 min | 7 min | 5 min | |
| When part A is mixed with | | | | | |
| part B at 1/1 mix ratio | | | | | |

Exothermic time was obtained by observing the time when 20 gram of the mixed adhesive in a 4 oz paper cup began to show apparent bubbling and temperature rise.

TABLE 14
Ambient Temperature Finger Joint Strength (in lbs) Development
Part A:Part B - 1:1
(Black Spruce Fir, 2″ × 3″ × 4′)

| | Part A | | | | |
|---|---|---|---|---|---|
| | 7225-138A | 7225-143A | 7225-143B | 7225-143C | Control |
| | Part B | | | | |
| | 7225-138B | 7225-138B | 7225-138B | 7225-138B | |
| 15 | 300 | 4,100 | 6,500 | 15,700 | 1,400 |
| min | | | | | |
| 30 | 5,400 | 18,700 | 22,400 | 25,700 | 2,100 |
| min | | | | | |
| 1 hr | 22,100 | 23,700 | 20,500 | 23,800 | 8,200 |
| 2 hr | 17,600 | 21,800 | 24,900 | 24,300 | 15,400 |
| 4 hr | 23,200 | 19,900 | 20,200 | 21,700 | 17,600 |
| 24 hr | 17,100 | 14,600 | 21,600 | 20,600 | 24,600 |

Control used was ISOSET UX 200/A300 two-part mix adhesive.
The solid black spruce fir without joint exhibits an average strength of ≈ 22,000 lbs.

### Example 8

### p-TSA Catalyzed Adhesive Using Hot Press

Data from Tables 3 and 4 from Example 1 indicated that the minimum required p-TSA concentration to cure QF2 is approximately 1%. To explore the lower limit of acid concentration, a study was initiated to determine bond performance relationship with acid concentration when wood laminates was hot pressed.

A series of part A aqueous solution was prepared by incorporating different p-TSA concentration in formulation shown in Table 15. The resulting solutions were then mixed with part B (7225-173, shown in Table 16) at 50/50 mix ratio for wood lamination. This wood laminates were hot (250° F.) pressed at 125 psi for 3 hrs before testing according to ASTM D-5751 test protocol.

Results shown in Table 16 demonstrate that when adhesive is heat cured, it requires a much lower acid concentration in the adhesive. The lower limit of p-TSA concentration to give good performance probably is between 0.5% and 0.75% in the adhesive mixture.

TABLE 15
Composition of Part A Containing p-TSA at Different Concentration

| | 7225- | 7225- | 7225- | 7225- | 7225- | 7225- |
|---|---|---|---|---|---|---|
| Ingredient | 187A | 187B | 187C | 161D | 187E | 187F |
| Quebracho | 96 | 96 | 96 | 96 | 96 | 96 |
| Water | 80 | 80 | 80 | 80 | 80 | 80 |
| CRC-373A | 3.6 | 5.42 | 7.26 | 9.12 | 11.0 | 12.92 |
| Calc. p-TSA | 1.00 | 1.49 | 1.98 | 2.46 | 2.94 | 3.42 |
| Conc. % | | | | | | |
| Initial viscosity | 1876 | 1492 | 1172 | 1164 | 880 | 868 |
| (cps) | | | | | | |

CRC-373A is 50% aqueous solution of p-TSA.

TABLE 16
Effect of Acid catalyst & its Concentration
ASTM D-5751 Performance on Black Spruce Fir (sp. gr. = 0.50)
Part A:Part B - 1:1, Part B: 7225-173
Hot (250°) Press at 125 psi for 3 hrs

| BN | Part A | Dry | Vacuum-p | 2-Cycle boil | Total Calc. |
|---|---|---|---|---|---|
| 7225- | 7225- | (wf %) | (wf %) | (wf %) | acid % |
| 187A | 187A | 1345 (62) | 643 (41) | 309 (31) | 0.50 |
| 187B | 187B | 1583 (78) | 868 (85) | 472 (62) | 0.75 |
| 187C | 187C | 1795 (46) | 888 (84) | 588 (51) | 1.00 |
| 187D | 187D | 1783 (63) | 979 (65) | 782 (73) | 1.23 |
| 187E | 187E | 1435 (61) | 926 (70) | 738 (72) | 1.47 |
| 187F | 187F | 1452 (74) | 912 (79) | 666 (69) | 1.71 |

7225-173 consists of water (10.14%), furfuryl alcohol (56.76%), methylcellulose (1.68%), Kaolin (28.46%), BR-100 (1.27%), and 5% NaOH (1.69%).

### Example 9

### P-TSA Salt Catalyzed Adhesive Using Hot Press

An effort was made effort to convert acid into its salt form for hot press application. In the process, the acid salt concentration relationship with the bond performance of wood laminates was explored. A series of part A solutions was prepared by incorporating p-TSA salt with two different degrees (80% and 95% in equivalent) of neutralization according to formulations shown in Table 17.

Wood laminates were prepared by applying adhesives derived from mixing part A solution and part B (7225-162, shown in Table 18) solution at 25/75 and 50/50 mix ratios and hot (250° F.) pressed at 125 psi for 2 hrs. Performance of ASTM D-5751 test shown in Table 18 demonstrates that the 50/50 mix ratio consistently gave better performance than the 25/75 mix ratio. It should be noted that the better performance at 50/50 mix ratio is not be viewed as having a higher calculated total p-TSA and salt concentration present in the adhesive. Rather, it should be viewed as due to the Quebracho/furfuryl alcohol ratio demonstrated from data shown in Tables 3 and 4 of Example 1. Results shown in Table 18 indicate that generally, good performance was not achieved until the total calculated p-TSA and salt concentration approaches 2-3%.

TABLE 17
Composition of Part A Containing Different
Acid Salt Catalyst Concentration & Degrees
of Neutralization (Equivalent Basis)

| | 95% Neutralization | | | 80% Neutralization | | |
|---|---|---|---|---|---|---|
| | 7225- | 7225- | 7225- | 7225- | 7225- | 7225- |
| | 159A | 159B | 159C | 159D | 159E | 159F |
| Quebracho | 104 | 104.7 | 102 | 107 | 104 | 103 |
| Water | 75.3 | 75.3 | 75.3 | 75.3 | 75.3 | 75.3 |
| p-TSA | 13.88 | 10.0 | 6.67 | 13.88 | 10.0 | 6.67 |
| CuO (II) | 2.75 | 1.98 | 1.32 | 2.32 | 1.67 | 1.11 |
| Viscosity (cps) | 3536 | 4248 | 4472 | 4376 | 3848 | 4608 |
| Calc. p-TSA + | 8.49 | 6.24 | 4.31 | 8.26 | 6.11 | 4.18 |
| CuO (II) conc. | | | | | | |
| (%) | | | | | | |

TABLE 18
Effect of Acid Salt Catalyst, Concentration, and
Degree of Neutralization (Equivalent Basis)
ASTM D-5751 Performance on Black Spruce Fir (sp. gr. = 0.50)
Adhesive: Part B (7225-162), CAT = 10–20 min
Hot (250° F.) Press at 125 psi for 2 hrs

| | | | | | | Calc. total p- |
|---|---|---|---|---|---|---|
| BN | Part A | | Dry | Vacuum-p | 2-cycle boil | TSA & salt |
| 7225- | 7225- | Mix ratio | (wf %) | (wf %) | (wf %) | conc % |

95% neutralization

| | | | | | | |
|---|---|---|---|---|---|---|
| -165A | -159A | 25/75 | 1401 (73) | 650 (77) | 608 (66) | 2.12 |
| -165B | -159A | 50/50 | 1528 (48) | 727 (76) | 463 (58) | 4.25 |
| -165C | -159B | 25/75 | 1017 (44) | 428 (30) | 194 (30) | 1.56 |
| -165D | -159B | 50/50 | 1553 (69) | 834 (68) | 596 (68) | 3.12 |
| -165E | -159C | 25/75 | No adhesion | — | — | 1.08 |
| -165F | -159C | 50/50 | 794 (42) | 630 (46) | 335 (53) | 2.16 |

80% Neutralization

| | | | | | | |
|---|---|---|---|---|---|---|
| -165G | -159D | 25/75 | 924 (34) | 774 (26) | 349 (46) | 2.07 |
| -165H | -159D | 50/50 | 1617 (75) | 945 (77) | 688 (74) | 4.13 |
| -165I | -159E | 25/75 | 735 (15) | 451 (25) | 154 (25) | 1.53 |
| -165J | -159E | 50/50 | 1828 (56) | 858 (61) | 755 (58) | 3.06 |
| -165K | -159F | 25/75 | No adhesion | — | — | 1.05 |
| -165L | -159F | 50/50 | 1469 (64) | 941 (92) | 624 (61) | 2.09 |

7225-162 consists of water (9.98%), furfuryl alcohol (55.88%), methylcellulose (1.50%), Kaolin (28.02%), BR-100 (2.66%), and 5% NaOH (1.95%).

### Example 10

### p-TSA Salt Catalyzed Adhesive Containing Emulsion Polymer Using Hot Press

We investigated the adhesive catalyzed by acid salt in emulsion polymer system. Various emulsion polymers were incorporated with p-TSA salt of CuO (II) at 95% neutralization at two different acid salt concentrations (2.45% and 7.06%), as part A component shown in Table 19. Two part B components were prepared. They were Quebracho/water/furfuryl alcohol at 40/15/45 ratio (designated as QWF—40/15/45) and Quebracho/furfuryl alcohol at 40/60 (designated as QF—40/60). Part A and part B were then mixed at 50/50 ratio to laminate black spruce fir to be hot (250° F.) pressed at 125 psi for 3 hrs.

ASTM D-5751 characterization results of wood laminates shown in Table 20 demonstrate that adhesive containing low (1.23%) acid salt concentration consistently gave better performance than adhesive containing high (3.53%) acid salt concentration. This is particularly noticeable with the vacuum pressure and 2-cycle boil test results. Among various emulsion polymers evaluated, Vinac 421 (entry 186C and 186C1) out-performed others judging from the strength and wood failure.

TABLE 19
Formulation of Emulsion Polymer Containing p-TSA Salt of CuO (II)

| | | Vinac | Vinac | Airflex | | |
|---|---|---|---|---|---|---|
| 7225- | Vinac 1000 | 421 | 427 | EP-17 | CuO (II) | CRC-373A |
| -184A | 100 | — | — | — | 0.46 | 4.21 |
| -184B | 100 | — | — | — | 1.46 | 13.29 |
| -184C | — | 100 | — | — | 0.46 | 4.21 |
| -184D | — | 100 | — | — | 1.46 | 13.29 |
| -184E | — | — | 100 | — | 0.46 | 4.21 |
| -184F | — | — | 100 | — | 1.46 | 13.29 |
| -184I | — | — | — | 100 | 0.46 | 4.21 |
| -184J | — | — | — | 100 | 1.46 | 13.29 |

CRC-373A is 50% aqueous solution of p-TSA.

TABLE 20
Effect of Acid Salt Catalyst and Concentration with Emulsion System
ASTM D-5751 Performance on Black Spruce Fir (sp. gr. = 0.50)
Part B: QWF at 40/15/45 and QF at 40/60, CAT = 10–20 min
Part A/Part B - 50/50
Hot (250° F.) Press at 125 psi for 3 hrs

| BN | Part A | Dry | Vacuum-p | 2-cycle boil |
|---|---|---|---|---|
| 7225- | 7225- | (wf %) | (wf %) | (wf %) |

Part B: QWF - 40/15/45

| | | | | |
|---|---|---|---|---|
| -186A | -184A | 1289 (43) | 802 (76) | 559 (68) |
| -186B | -184B | 1136 (52) | 559 (29) | 196 (63) |
| -186C | -184C | 1615 (92) | 810 (96) | 653 (74) |
| -186D | -184D | 1269 (41) | 773 (48) | 314 (42) |
| -186E | -184E | 1249 (87) | 707 (77) | 33 (0) |
| -186F | -184F | 905 (56) | 693 (57) | 316 (37) |
| -186I | -184I | 1409 (69) | 718 (64) | 71 (5) |
| -186J | -184J | 1091 (40) | 525 (19) | 110 (14) |

Part B: QF - 40/60

| | | | | |
|---|---|---|---|---|
| -186A1 | -184A | 1041 (49) | 755 (77) | 710 (51) |
| -186B1 | -184B | 649 (36) | 481 (31) | 230 (22) |
| -186C1 | -184C | 1475 (78) | 872 (86) | 836 (70) |
| -186D1 | -184D | 1198 (46) | 666 (30) | 404 (35) |
| -186E1 | -184E | 1078 (89) | 562 (89) | — |
| -186F1 | -184F | 963 (50) | 537 (15) | 274 (26) |
| -186I1 | -184I | 1678 (64) | 701 (60) | 36 (1) |
| -186K1 | -184J | 852 (56) | 332 (21) | 9.4 (0) |

While the invention has been described with reference to various embodiments, those skilled in the art will understand that various changes may be made and equivalents may be substituted for elements thereof without departing from the scope and essence of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. Also, all citations referred herein are expressly incorporated herein by reference.

We claim:

1. A two-part adhesive composition suitable for engineered wood applications, which comprises:
(a) Part A comprising an aqueous mixture of tannin and furfuryl alcohol, but being devoid of catalyzing acid;
(b) Part B comprising an aqueous mixture of polymer, clay, thickeners, and catalyzing acid.

2. The adhesive composition of claim 1, wherein the weight ratio of tannin to furfuryl alcohol ranges from between about 20:80 and 50:50.

3. The adhesive composition of claim 1, wherein the pH of said clay is not substantially higher than about 7.0.

4. The adhesive composition of claim 1, wherein said tannin is derived from one or more of Quebracho. wattle, oak, eucalyptus, birch, willow, pine, mimosa bark, pecan nut pith, gambier shoot, gambier leaf, chestnut, or mimosa.

5. The adhesive composition of claim 1, wherein said polymer is an aqueous emulsion polymer.

6. The adhesive composition of claim 5, wherein said aqueous emulsion polymer is one or more of polyvinyl acetate copolymers, vinyl acetate-ethylene copolymers, vinyl-ethylene-chloride copolymers, or vinyl acetate copolymer emulsions, or acrylic emulsions.

7. The adhesive composition of claim 1, which additionally comprises one or more of: an organic acid catalyst or an inorganic acid; one or more acid salts; or a water-soluble thickener.

8. An adhesive composition suitable for engineered wood applications, which comprises:
(a) Part A comprising an aqueous solution of tannin extract and catalyzing acid or acid salt;
(b) Part B comprising an aqueous mixture of furfuryl alcohol, polymer, clay, and thickeners but being devoid of catalyzing acid.

9. The adhesive composition of claim 8, wherein the weight ratio of tannin to furfuryl alcohol ranges from between about 20:80 and 50:50.

10. The adhesive composition of claim 8, wherein the pH of said clay is not substantially higher than about 7.0.

11. The adhesive composition of claim 8, wherein said tannin is derived from one or more of Quebracho. wattle, oak, eucalyptus, birch, willow, pine, mimosa bark, pecan nut pith, gambier shoot, gambier leaf, chestnut, or mimosa.

12. The adhesive composition of claim 8, wherein said polymer is an aqueous emulsion polymer.

13. The adhesive composition of claim 12, wherein said aqueous emulsion polymer is one or more of polyvinyl acetate copolymers, vinyl acetate-ethylene copolymers, vinyl-ethylene-chloride copolymers, or vinyl acetate copolymer emulsions, or acrylic emulsions.

14. The adhesive composition of claim 1, which additional comprises one or more of: an organic acid catalyst or an inorganic acid; one or more acid salts; a water soluble thickener; or one or more fillers or clays having a pH not substantially greater than about 7.0.

15. The adhesive composition of claim 8, which additionally comprises one or more of: an organic acid catalyst or an inorganic acid; one or more acid salts; or a water-soluble thickener.

16. An aqueous two part adhesive composition, Part A and Part B, suitable for engineered wood applications, which parts are only combined for application, which comprises:
tannin, furfuryl alcohol, catalyzing acid, and additives, provided that said furfuryl alcohol and said catalyzing acid are not present in the same Part.

17. The aqueous two part adhesive composition of claim 16, wherein the weight ratio of tannin to furfuryl alcohol ranges from between about 20:80 and 50:50.

18. The adhesive composition of claim 16, wherein said tannin is derived from one or more of Quebracho. wattle, oak, eucalyptus, birch, willow, pine, mimosa bark, pecan nut pith, gambier shoot, gambier leaf, chestnut, or mimosa.

19. The adhesive composition of claim 16, wherein said polymer is an aqueous emulsion polymer.

20. The adhesive composition of claim 19, wherein said aqueous emulsion polymer is one or more of polyvinyl acetate copolymers, vinyl acetate-ethylene copolymers, vinyl-ethylene-chloride copolymers, or vinyl acetate copolymer emulsions, or acrylic emulsions.

21. The adhesive composition of claim 1, which additional comprises one or more of: an organic acid catalyst or an inorganic acid; or one or more acid salts; a water-soluble thickener.

22. An engineered wood product having a pair of surfaces bonded by the dried residue of an adhesive composition comprising:
a two-part adhesive composition, which comprises:
(a) Part A comprising an aqueous mixture of tannin and furfuryl alcohol, but being devoid of catalyzing acid;
(b) Part B comprising an aqueous mixture of polymer, clay, thickeners, and catalyzing acid.

23. The engineered wood product of claim 22, wherein the weight ratio of tannin to furfuryl alcohol ranges from between about 20:80 and 50:50.

24. The engineered wood product of claim 22, wherein the pH of said clay is not substantially higher than about 7.0.

25. The engineered wood product of claim 22, wherein said tannin is derived from one or more of Quebracho. wattle, oak, eucalyptus, birch, willow, pine, mimosa bark, pecan nut pith, gambier shoot, gambier leaf, chestnut, or mimosa.

26. The engineered wood product of claim 22, wherein said polymer is an aqueous emulsion polymer.

27. The engineered wood product of claim 26, wherein said aqueous emulsion polymer is one or more of polyvinyl acetate copolymers, vinyl acetate-ethylene copolymers, vinyl-ethylene-chloride copolymers, or vinyl acetate copolymer emulsions, or acrylic emulsions.

28. The engineered wood product of claim 22, which additionally comprises one or more of: an organic acid catalyst or an inorganic acid; one or more acid salts; or a water-soluble thickener.

29. An engineered wood product having a pair of surfaces bonded by the dried residue of an adhesive composition comprising:
a two-part adhesive composition, which comprises:
(a) Part A comprising an aqueous solution of tannin extract and catalyzing acid or acid salt;
(b) Part B comprising an aqueous mixture of furfuryl alcohol, polymer, clay, and thickeners but being devoid of catalyzing acid.

30. The engineered wood product of claim 29, wherein the weight ratio of tannin to furfuryl alcohol ranges from between about 20:80 and 50:50.

31. The engineered wood product of claim 29, wherein the pH of said clay is not substantially higher than about 7.0.

32. The engineered wood product of claim 29, wherein said tannin is derived from one or more of Quebracho. wattle, oak, eucalyptus, birch, willow, pine, mimosa bark, pecan nut pith, gambier shoot, gambier leaf, chestnut, or mimosa.

33. The engineered wood product of claim 29, wherein said polymer is an aqueous emulsion polymer.

34. The engineered wood product of claim 33, wherein said aqueous emulsion polymer is one or more of polyvinyl acetate copolymers, vinyl acetate-ethylene copolymers, vinyl-ethylene-chloride copolymers, or vinyl acetate copolymer emulsions, or acrylic emulsions.

35. The engineered wood product of claim 29, which additionally comprises one or more of: an organic acid catalyst or an inorganic acid; one or more acid salts; or a water-soluble thickener.

36. A method for manufacturing an engineered wood product having a pair of surfaces bonded by the dried residue of an adhesive composition comprising:
(1) applying an adhesive composition to at least one of the surfaces to be bonded, said adhesive composition comprising a two-part adhesive composition, which comprises:
(a) Part A comprising an aqueous solution of tannin extract and catalyzing acid or acid salt;
(b) Part B comprising an aqueous mixture of furfuryl alcohol, polymer, clay, and thickeners but being devoid of catalyzing acid; or
(a) Part A comprising an aqueous mixture of tannin and furfuryl alcohol, but being devoid of catalyzing acid;
(b) Part B comprising an aqueous mixture of polymer, clay, thickeners, and catalyzing acid; and
(2) curing said two-part adhesive composition.

37. The method of claim 36, wherein said curing is one or more of ambient temperature cure, elevated temperature cure, radio frequency (RF) cure, or microwave cure.

38. The method of claim 36, wherein the weight ratio of tannin to furfuryl alcohol ranges from between about 20:80 and 50:50.

39. The method of claim 36, wherein the pH of said clay is not substantially higher than about 7.0.

40. The method of claim 36, wherein said tannin is derived from one or more of Quebracho. wattle, oak, eucalyptus, birch, willow, pine, mimosa bark, pecan nut pith, gambier shoot, gambier leaf, chestnut, or mimosa.

41. The method of claim 36, wherein said polymer is an aqueous emulsion polymer.

42. The method of claim 42, wherein said aqueous emulsion polymer is one or more of polyvinyl acetate copolymers, vinyl acetate-ethylene copolymers, vinyl-ethylene-chloride copolymers, or vinyl acetate copolymer emulsions, or acrylic emulsions.

43. The method of claim 36, wherein said two-part adhesive composition additionally comprises one or more of: an organic acid catalyst or an inorganic acid; one or more acid salts; or a water-soluble thickener.
